(19) United States
(12) Patent Application Publication
(10) Pub. No.: US 2003/0226918 A1
(43) Pub. Date: Dec. 11, 2003

(54) Safety and water conserving flush system for comminuting apparatus

(76) Inventor: Jan Gerstel, Agoura Hills, CA (US)

Correspondence Address: Marshall E. Rosenberg, Esq., The Gilbert Law Building, 22130 Clarendon Street, Woodland Hills, CA, 91367, US

(21) Appl. No.: 10/164,122

(22) Filed: Jun. 5, 2002

(51) Int. Cl. B02C 25/00

(52) U.S. Cl. 241/30; 241/46.012; 241/46.013

(57) ABSTRACT

A waste comminuting system and method of use therefore is disclosed, including enhanced safety and water conserving features. The apparatus includes sensor and programming means for enabling coordinated, automated operation of the waste comminuting system based on a schedule of operating conditions, further enabling programmable scheduling of a safety shutter and a water supply common to fluid flow from an automated dishwasher, during concurrent operation of the dishwasher upon actuation by a common controller.

### FIELD OF THE INVENTION

The present invention is directed generally to comminuting devices such as garbage disposers, and more specifically to an improved garbage disposer with water-conserving and safety features for use therewith.

### BACKGROUND OF THE INVENTION

Many kitchens, including residential and commercial kitchens, are equipped with comminuting devices commonly referred to as garbage disposals for disposing food scraps and trimmings. More particularly, such comminuting devices are designed to grind waste such as food waste into a small enough particulate size to be picked up, readily carried by and flushed into a downstream waste disposal system such as a sewer system or septic tank by a water flow, typically provided as a stream of water. In common domestic use, a garbage disposal is attached to the drain of a kitchen sink adjacent to the food preparation area for convenient disposal of such food and biodegradable waste. It will be appreciated that the water stream for use with such garbage disposal systems is intended to flush the drain line before, during and following the comminuting procedure, as well as to assist in the complete evacuation of partially and fully ground refuse through the drain line during the grinding process, and failure to use a sufficient amount of water often results in clogs and backups of the drain lines, and even failure of the garbage disposal itself often due to overloading of the disposer motor caused by insufficient evacuation of the waste load from the grinding chamber.

Garbage disposals are commonly actuated by a power switch located at an operationally convenient location remote from the garbage disposal, for example, on a counter or wall adjacent the sink, although within reasonable operating reach of the disposal operator. The commonly accepted practice of operating a garbage disposer includes introducing a stream of water into the disposer prior to actuating the comminuting apparatus of the disposer, to allow the water to serve as a lubricant within the disposer as well as a vehicle for easily carrying and flowing the comminuted waste and resulting effluent into the downstream plumbing system leading to the waste disposal system. It is also commonly advised to introduce the water stream to the disposer prior to and during disposer actuation, and to continue flowing that water stream for a period of time even after apparent completion of the grinding task to assure complete flushing of resulting comminuted waste into and through the drain system.

However, it is a common mistake for disposer operators to halt the water stream immediately following the grinding task, resulting in the incomplete flushing and disposal of the water-borne waste product into the waste disposal system. Likewise, it is a common mistake to delay the initiation of the water stream into the disposer. These actions compromise the cooling and lubrication effects that the water stream provides to the comminuting apparatus and hence the garbage disposal motor operating under the load of the comminuting process apparatus during and shortly after actual activation of the disposer. It is known that some users provide an excessive amount of water preliminary to, or alternatively, following the grinding task. More particularly, in operation, a user initiates a flow of water into the garbage disposal, activates the disposal, waits while the disposal grinds the refuse, deactivates the disposal, and then discontinues the water flow (after making a subjective audible determination that the grinding operation is complete), in that order.

As noted above, the desired initial water flow may be undesirably delayed, as this process requires the user to remember to turn on the water before activating the disposer, continue running it during the complete grinding and disposal cycle, and deactivating the disposer after the grinding cycle to allow a sufficient period of additional flushing time to assure complete discharge of the waste products of the grinding cycle to the downstream waste disposal system. Thus, important problems in the prior art include the failure to operate the water stream on-time or for a sufficiently long enough period of time necessary to fully flush the disposer and downstream waste disposal system, and failure to do that commonly causes overheating, seizing, and related problems to the disposer. It is further recognized that other kitchen appliances utilize excess water flows that have heretofore not been harnessed in a beneficial, water-conserving manner.

In addition to the above-noted problems, exposure of high-speed rotating cutting/grinding elements of the disposer presents a well-known safety hazard to users in the immediate vicinity of the drain, as well as to any objects that inadvertently fall into the grinding chamber of the disposer. In particular, objects not intended to be comminuted and flushed by the disposer and waste disposal systems of the related art may be inadvertently dropped or deposited into the grinding chamber of the disposer. It is also known that disposer operators may attempt to retrieve such objects and thus place one or more fingers, hand or a makeshift retrieval tool in peril by attempting to locate and remove such objects from the grinding chamber.

Yet, the grinding chamber must be made available to receive waste matter in the manner described. Accordingly, there remains a need to address the related issues of preventing injury to the disposer operator resulting from uncontrolled access to the grinder chamber, as well as the need to provide a necessary stream of water, in a water-conservative manner, to the disposer during and after the actual grinding action, without negatively affecting access to and use of the disposer for its intended purpose, while providing measurably significant water-conserving methods.

### OBJECTS AND SUMMARY OF THE INVENTION

It is thus an object of the present invention to provide an improved garbage disposer that provides enhanced water stream control for optimizing disposer operation, utilizing water conservation measures.

It is another object of the present invention to provide an improved garbage disposer that provides enhanced safety features during its operation.

It is a further object of the present invention to further optimize and conserve the use of water during the operation of garbage disposers.

It is yet a further object of the present invention to optimize and conserve the use of water during disposer operation by utilizing an available effluent or supplemental water flow generated and otherwise wasted by a counterpart appliance.

These and other objects are met by the present invention which is directed to apparatus and methods of operating a waste comminuting system such as a common kitchen food disposer for providing enhanced water conserving and safety benefits. The apparatus includes a system controller, sensors and programming means for enabling coordinated, automated operation of the waste comminuting system based on a schedule of operating conditions, further enabling programmable scheduling of a water supply common to fluid flow from an automated dishwasher, during concurrent operation of the dishwasher upon actuation by the controller.

### BRIEF DESCRIPTION OF THE DRAWINGS

FIG. 1 is a schematic drawing of the waste disposer system of the present invention, showing a garbage disposer plumbed to a sink and water supply, and another water-using appliance such as an automatic dishwasher.

FIG. 2 is a top plan view of one embodiment of a portion of a safety shutter for use with the waste disposer system of the present invention shown in FIG. 1.

FIG. 3 is a top plan view of another embodiment of a portion of a safety shutter for use with the waste disposer system of the present invention shown in FIG. 1.

### DETAILED DESCRIPTION OF THE PREFERRED EMBODIMENTS

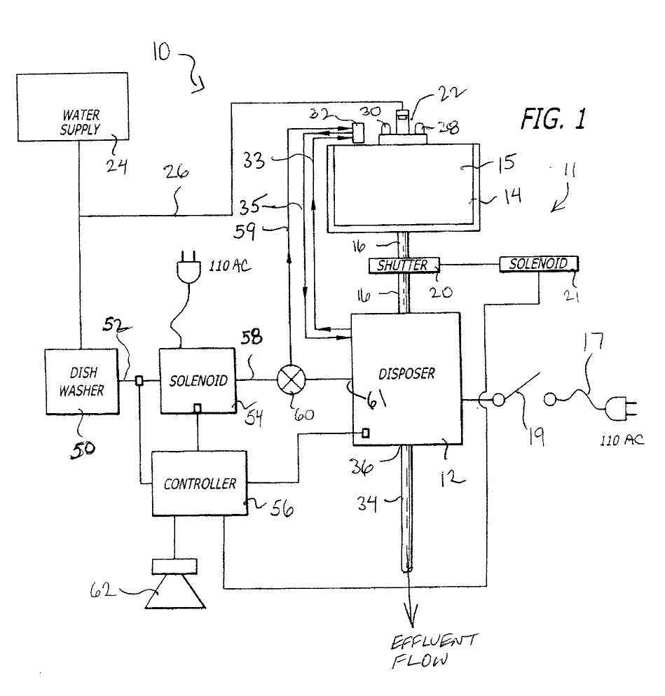

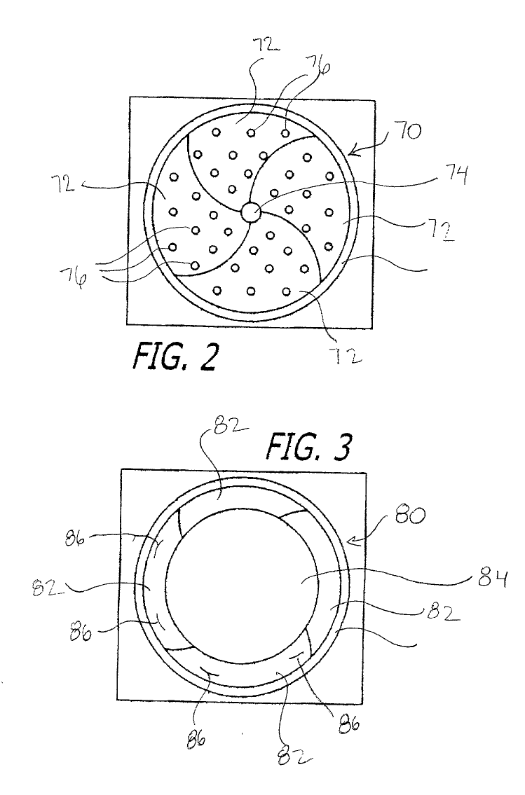

With reference now to the drawing figures, FIG. 1 shows the safety and water conserving flush system 10 of the present invention. The invention generally includes a comminuting device commonly known as a food disposer or garbage disposer 11. Disposer 11 including a waste receiving and comminuting chamber 12 that is mounted to or located downstream of a sink 14 having a waste-receiving basin 15, either by direct connection of an inlet of the disposer 11 affixed to an outlet of the sink 14, or via duct 16 as shown in FIG. 1 for outputting an unprocessed effluent stream discharging from sink 14 to disposer 12. Disposer 11 is operated by a house power supply, such as a 110 volt AC supply 17, controlled by switch 19. As will be more fully described below, and according to an important aspect of the present invention, a shutter 20 (a plurality of embodiments of which are shown in FIGS. 2 and 3) controls effluent flow into the disposer 12 discharged from the sink.

As will be appreciated by the skilled artisan, a water flow may be introduced to the sink 14 having basin 15 from a faucet 22 supplied by water supply 24 carried by conduit or duct 26 extending therefrom. Although a single duct 26 is shown, it is to be understood that plural ducts may provide separate water flows from supplies of heated or unheated water to faucet 22, which is provided with a cold water valve 28 and a hot water valve 30. An air vent 32 plumbed to vent line 33, 35 is provided to vent pressure build-up in the disposer 12 during operation, and thereby prevent a back-pressure buildup in effluent duct 34 mounted to outlet 36 of disposer 12, in conjunction with local building codes as may be applicable. Discharge or effluent duct 34 further extends to a downstream waste disposal system such as a sewer system, septic tank or holding tank (not shown) for disposal of the waste stream introduced to sink 14 and subsequently processed by operation of disposer 12.

According to the invention, a water flow such a an effluent flow from another water-using appliance, such as a dishwasher 50 is employed for use with the disposer 12. The effluent flow outputted through conduit 52 is directed to the chamber 12 of disposer 11 via operation of solenoid 54 acting under control of system controller 56, and may optionally be plumbed into a water supply line, preferably but not limited to the cold water supply line in that instance. The effluent flow downstream of solenoid 54 is directed through conduit 58, subject to air pressure relief via check valve/air vent 32 plumbed to vent line 59.

As will be more fully described, the system 10 when actuated commands the system controller 56 to oversee the entire disposer cycle, operating either under control of one or more factory-set program functions including water and timing parameters, or under control of user-defined parameters, while preferably switching the shutter 20 to a closed position, the perforations 76, 86 (FIGS. 2, 3) allowing a water flow therethrough in the closed position. For exemplary purposes only, it will be appreciated by the skilled artisan that different water flow rates and start/stop timing settings may be programmed, in connection with one or more different timing cycles, to provide for sufficient water flow before, during and immediately after cycling of the disposer 11. It will further be understood that one or more sensors 62 may detect flow and flow rates, based on measurements made by sensed flow characteristics that are compared with predetermined parameters including characteristics selected from the group including optical, electrical, electronic, and mass measurements. Sensors 62 may be positioned in line with duct 16, duct 26, duct 52, within or in-line with dishwasher 50 or chamber 15, or grinder chamber 12 to provide the necessary and desirable feed back to controller 56. The system controller 56 further reads sensor information ascertaining that the shutter 20, 70, 80 is in the closed position via operation of solenoid 21 during operation of the disposer 11 to safeguard against operation of the disposer 21 in an unprotected condition when the shutter 20, 70, 80 is in the open position. Accordingly, in use, the operator need merely operate a master control switch, and the controller in turn actuates closure of the safety shutter, initiates a pre-grinding water flow, and then continues that water (or other fluid as is more fully described below) flow as necessary to assure complete grinding and flushing, with an appropriate after-flow to clear the effluent line and cool the disposer 11.

Concurrently, the controller 56 further utilizes effluent flow 52 from the dishwasher 50, supplementing it as necessary with a water flow from water supply 24. It will be appreciated that the system may be programmed to operate when a substantial effluent flow is known to become imminently available from the dishwasher 50 or other water-using appliance (not shown) or other water-based stream (also not shown) directed through valve 60 and discharging directly into receiving and comminuting chamber 12 via inlet 61, thereby maximizing this water-conserving technique. Alternatively, the controller may be programmed to sense a sufficient waste load before operating. It will be further appreciated that a supplemental water flow may be provided by, and controlled by the present invention, from other kitchen or non-kitchen appliances that provide a quantifiable water outflow, including but not limited to condensate flow from refrigerators and freezers, water chillers and air conditioners, or other gray-water sources known in residential and commercial buildings and operations.

In connection with the primary operation of the inventive system 10, and now referring to FIGS. 2 and 3, the controller 56 actuates shutters 20, 70, 80 as an important safety feature to prevent unintended deposits into the grinding chamber 12 during operation of the disposer 11. Specifically, shutters 20, 70, 80 remain engaged under control of solenoid 21 during operation of the system 10. With specific reference to FIG. 2, shutter 70 includes a plurality of overlapping leaves or paddles 72, which act under centrifugal force in an iris-type arrangement to close the opening 74 to the grinder chamber 12 during operation of the disposer 11. The leaves or paddles 72 may be perforated or otherwise slitted, slotted or meshed with perforations 76 to enable a water flow from water supply 24 venting though duct 26 and faucet 22, or to allow for draining of another fluid discharged into sink 14. Likewise, with reference to FIG. 3, shutter 80 includes a plurality of overlapping leaves or paddles 82, which act under centrifugal force in an iris-type arrangement to close the opening 84 to the grinder chamber 12 during operation of the disposer

The leaves or paddles 82 may be perforated or otherwise slitted, slotted or meshed with perforations 86 to enable a water flow from water supply 24 venting though duct 26 and faucet 22. A manual override is provided to open the shutter 20, 70, 80 as may be necessary to clear or service the grinding chamber 12. According to any of the disclosed embodiments, the shutter 20, 70, 80 is substantially or completely closed during the grinding operation (and optionally during the pre-grinding operation), and again returns to the open position after the system is cycled, subject to controller programming.

Although the present invention has been described with respect to the several preferred embodiments, modifications and alterations can be made without departing from the invention. Accordingly, it is intended that all such modifications and alterations be considered as being within the spirit and scope of the invention as defined by the attached claims.

I claim:

1. A waste comminuting system for receiving and comminuting a waste stream discharging from a sink, comprising:
a receiving and comminuting chamber having an inlet and an outlet;
a fluid supply inlet for introducing a first fluid stream to the receiving and comminuting chamber;
a shutter operable between a closed position and a non-closed position for safeguarding against deposition of objects other than the first fluid stream to the receiving and comminuting chamber, the shutter including at least one opening therethrough for communicating the first fluid stream into the receiving and comminuting chamber when the shutter is in the closed position; and
a feedback control system for controlling coordinated, automated operation of the waste comminuting system based on a schedule of operating conditions.

2. The waste comminuting system as recited in claim 1, wherein the first fluid stream is comprised of water provided from a water supply.

3. The waste comminuting system as recited in claim 1, wherein the chamber is adapted to receive solid, liquid, or a mixed solid-liquid waste.

4. The waste comminuting system as recited in claim 1, wherein the operating schedule is programmable.

5. The waste comminuting system as recited in claim 4, wherein the schedule enables selective introduction of the fluid supply by timing and rate of flow.

6. The waste comminuting system as recited in claim 5, wherein the fluid supply is introduced to the chamber prior to introduction of waste.

7. The waste comminuting system as recited in claim 5, wherein the fluid supply is maintained during commination and draining of the resulting slurry.

8. The waste comminuting system as recited in claim 5, wherein the fluid supply is terminated following completion of a schedule of sensory return information.

9. The waste comminuting system as recited in claim 8, wherein the sensory return is based on sensed flow characteristics.

10. The waste comminuting system as recited in claim 9, wherein the sensed flow characteristics are compared with preselected parameters including characteristics selected from the group including optical, electrical, electronic, and mass measurements.

11. The waste comminuting system as recited in claim 2, wherein the water supply is common to a fluid stream from an automated dishwashing system, and is operable upon concurrent actuation by a common controller.

12. The waste comminuting system as recited in claim 1, further including a visual or audible indicator indicating an operating condition of the system.

13. The waste comminuting system as recited in claim 1, further including manual override operability of the shutter.

14. The waste comminuting system as recited in claim 11, further comprising a second fluid stream introduced directly into the receiving and comminuting chamber.

15. A waste comminuting system for use in connection with an automatic dishwashing system, comprising:
a receiving and comminuting chamber having an inlet and an outlet;
a water supply inlet for introducing a water stream to the receiving and comminuting chamber;
a shutter operable between a closed operating position and a non-closed non-operating position for controlling access to the receiving and comminuting chamber, the shutter including at least one opening for flowing the water stream therethrough when the shutter is in the closed operating position;
and wherein the water supply is common to fluid flow from an automated dishwasher, and is operable upon concurrent actuation by a common controller; and
a sensor for enabling coordinated, automated operation of the waste comminuting system based on a schedule of operating conditions.

16. The waste comminuting system as recited in claim 15, wherein the operating schedule is programmable.

17. The waste comminuting system as recited in claim 16, wherein the schedule enables selective introduction of the fluid supply by timing and rate of flow.

18. The waste comminuting system as recited in claim 15, wherein the fluid supply is introduced to the chamber prior to introduction of waste.

19. The waste comminuting system as recited in claim 15, wherein the fluid supply is maintained during commination and draining of the resulting slurry.

20. The waste comminuting system as recited in claim 15, wherein the fluid supply is terminated following a schedule of sensory return information.

21. The waste comminuting system as recited in claim 20, wherein the sensory return is based on sensed flow characteristics.

22. The waste comminuting system as recited in claim 20, wherein the sensed flow characteristics are compared with predetermined parameters including characteristics selected from the group including optical, electrical, electronic, and mass measurements.

23. A method of operating a waste disposer having a receiving and comminuting chamber, comprising:
positioning a safety shutter adjacent to the receiving and comminuting chamber;
introducing a fluid supply to the chamber;
introducing waste matter to the chamber;
closing the safety shutter at least during the comminuting process; and
providing a coordinated, automated operation of the safety shutter prior to, during, and following the comminuting process.

24. The method as recited in claim 23, further comprising:
providing a schedule of sensed operating conditions.

25. The method as recited in claim 23, further comprising:
controlling access to the receiving and comminuting chamber during operation of the system.

26. The method as recited in claim 25, further comprising:
providing selective control over entry to the receiving and comminuting chamber.

27. The method as recited in claim 25, further comprising:
enabling introduction of a supplemental fluid flow to the receiving and comminuting chamber during operation of the system.

28. The method as recited in claim 25, further comprising:
providing selective control over entry to the receiving and comminuting chamber.

29. The method as recited in claim 25, further comprising:
operating the system concurrently with an automated dishwashing system, utilizing a common water supply therebetween.
